(19) United States
(12) Patent Application Publication
(10) Pub. No.: US 2008/0105692 A1
(43) Pub. Date: May 8, 2008

(54) Dual container for heating and heat retaining

(76) Inventor: Junji Hiromori, Tokyo (JP)

Correspondence Address: JORDAN AND HAMBURG LLP, 122 EAST 42ND STREET, SUITE 4000, NEW YORK, NY, 10168, US

(21) Appl. No.: 11/799,585

(22) Filed: May 2, 2007

(30) Foreign Application Priority Data
Nov. 2, 2006 (JP) 2006-008946

(51) Int. Cl. A47J 41/00

(52) U.S. Cl. 220/592.16

(57) ABSTRACT

Conventionally, a dual cup is known which provides an air thermal insulating layer between a metal inner container and outer container. Since the dual cup totally comprises double layers, it can not be heated with an electric heater. In addition, manufacturing of the dual cup is costly. Therefore, a dual cup of the present invention is provided which comprises a bottom portion being one layer to improve heat absorption even with an electric heater by a weak power from a dry battery or a USB hub of personal computer, and which comprises a side portion being in two layer structure for defining an air thermal insulating layer by hermetically sealing air to improve heat retaining effect.

### BACKGROUND OF THE INVENTION

1. Field of the Invention

The present invention generally relates to containers, and in particular to metal dual containers such as cups, pots and so on for efficient heating and heat retaining placed on an electric heater with a weak heat source.

2. Description of Related Art

For heating and heat retaining of coffee and so forth, metal cups are usually placed on an electric heater as a heat source by using dry batteries or a USB hub of personal computers.

In case of using such an electric heater, conventional metal cups can be used. However, only a weak electric current can be obtained from such an electric source. Therefore, heat retaining would be more efficient if cups or pots themselves have an improved heat retaining effect. Accordingly, it is desirable to use a dual container.

However, a dual cup having a dual structure composed of an inner container and an outer container makes it hard to transmit heat so as to prevent heat in the cup from being dissipated to keep temperature of the inside of the cup. When heating from outside, heat is difficult to transmit to the inner container, let alone coffee and so on therein. Therefore, the dual cup is suitable for heat-retaining but unsuitable in itself as a container for heating because of its low heating efficiency.

In addition, there are two types of dual cups, one is a type with a vacancy between the inner container and the outer container as in thermos bottles, and the other is a type with an air thermal insulating layer defined by sealing the air between the inner container and the outer container so as to keep temperature. The latter type has a sufficient effect for a container such as a dual cup or a pot for heating and heat-retaining by using an electric heater. In a sense, a dual container of the former type with much higher manufacturing cost is not necessary. However, even in the latter type, the cost of manufacturing is relatively high compared to a normal cup. Therefore, it is necessary to provide a low-price dual container with as simple a manufacturing process as possible.

### SUMMARY OF THE INVENTION

A first aspect of the present invention is a metal dual container for heating and heat retaining, comprising a bottom plate portion made of one layer and a side portion made of two layers for sealing air therebetween to define an air thermal insulating layer.

A second aspect of the present invention is a dual container for heating and heat retaining according to the first of the present invention, comprising an outer container and an inner container, wherein a bottom portion of the outer container defines an opening surrounded by a remaining peripheral portion of the bottom portion, and wherein a bottom portion of the inner container is shouldered and a lower portion of the bottom portion is narrower under the shoulders, and a bottom plate portion of the inner container is positioned below the opening of the outer container thereby to form the bottom plate portion of the dual container and respective side portions of the inner container and the outer container form the dual container side portion made of two layers.

A third aspect of the present invention is a dual container for heating and heat retaining according to the second of the present invention, wherein a clearance between the outer container and the inner container is sealed with an elastic synthetic resin ring at the bottom portion of the outer container.

A fourth aspect of the present invention is a dual container for heating and heat retaining according to the third of the present invention, wherein the elastic synthetic resin ring has a generally U-shaped section.

### BRIEF DESCRIPTION OF THE DRAWINGS

The present invention will be described herein below with reference to various figures, to which the scope of the present invention is not limited, in which:

FIG. 1 is a perspective view of a metal dual cup according to the present invention;

FIG. 2 is a central, longitudinal, sectional view of FIG. 1;

FIG. 3 is a perspective view of an elastic synthetic resin ring;

FIG. 4 is a enlarged sectional view of the elastic synthetic resin ring;

FIG. 5 is a front view of an embodiment of the present invention; and

FIG. 6 is a graph showing a temperature change.

### DESCRIPTION OF THE PREFERRED EMBODIMENTS

One of the preferred embodiments of the present invention comprises a metal dual container for heating and heat retaining, wherein the inner container and the outer container are melted and attached or welded to each other at their upper portions, a bottom portion of the inner container is shouldered and a lower portion of the bottom portion is smaller under the shoulders, the bottom portion is extended below the opening of the outer container, and a small space is provided between the periphery of the outer container surrounding the opening and the inner container so as to avoid the contact between both the containers at the portions, wherein the clearance between the inner container and the outer container is sealed with the silicone resin ring having a generally U-shaped section which has upper and lower thin end portions at the radially outer side.

### EXAMPLE 1

One example of a metal dual cup will be explained hereunder according to the attached drawings.

1 represents an inner container and 2 represents an outer container. The cup is in a two-layer structure, at its side, comprising the inner container 1 and the outer container 2. Material of the containers preferably includes metals with high thermal conductivity, such as stainless steel sheets, sheet copper, sheet iron, aluminum sheets and so on. The thickness is preferably about 1 mm from the viewpoint of strength, weight and difficulty of workability of the metals.

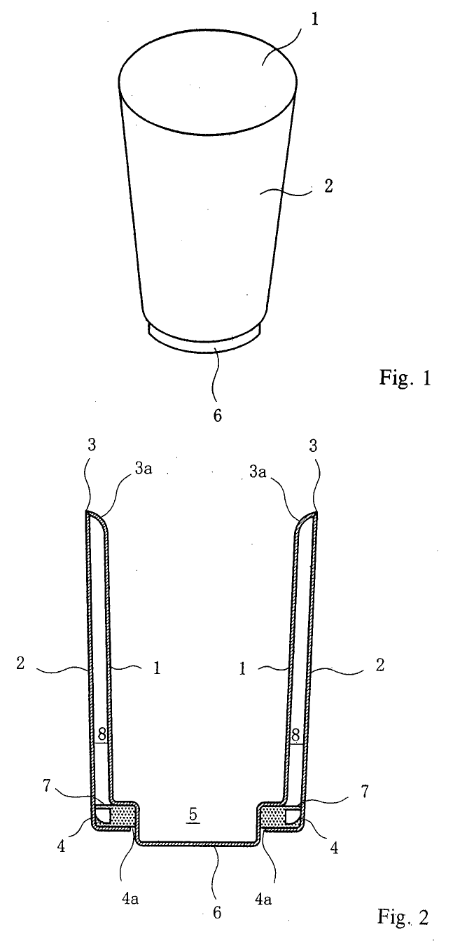

The inner container 1 is of a cylindrical shape with a bottom, upper end portions 3a and 3a are gently outwardly curved surface and the bottom portion has a downwardly cylindrically protruded or sunken portion 5 wherein its bottom plate portion 6 is flat, as shown in the sectional view of FIG. 2. The bottom plate portion 6 can be in direct contact with an electric heater 9 in order to be heated.

The shape of the upper peripheral portions 3a, 3a of the inner container 1 in this example is most preferable because one can drink easily with a container having such a shape and also such a shape has good appearance. However the shape of the portions 3a, 3a are not necessarily an outwardly curved surface as shown in FIG. 2.

Such a curved surface is formed for defining a space 8 between the inner container 1 and the outer container 2. Accordingly, the upper peripheral portions of either or both of the inner container 1 and the outer container 2 can be a curved surface. In addition, the inner container 2 can be of an inverted frustoconical shape wherein the diameter of the inner container 1 is smaller at a lower position at a higher rate than the rate at which the diameter of the outer container is smaller at a lower position.

The shape of the inner container 1 is not limited to a cylindrical shape but can be any shape, for example, a shape the upper portion of which is larger in size like a commonly-used tea cup, a quadrangular prism, other polyangular prism or column and so forth which can be used as a container such as cups or pots and so on.

The undersurface 6 of the inner container 1 is flat. However, antislip projections and depressions, such as multiple circles, spirals and so on can be provided on the undersurface 6.

The outer container 2 is of a cylindrical shape and the bottom defines an opening surrounded by remaining peripheral portions 4, 4 of the bottom, and the sunken portion 5 of the inner container 1 is penetrated through the opening.

As shown in FIG. 2, there is a small space between the perimeters 4a, 4a of the opening and the sunken portion 5 so that they are not in contact with each other. This is because, when the inner container and the outer container are assembled as will be explained in paragraph 36 below, the opening is slightly larger than the sunken portion 5 so that the sunken portion 5 of the inner container can be received easily thereby making it easy to assemble both the containers, and because, in case that the inner container 1 and the outer container 2 are not in contact with each other at the portions, high heating efficiency can be obtained due to the inner container 1 being only heated first without heat transfer to the outer container 2 via the peripheral portions 4, 4. Needless to say, however, it is also possible that the perimeters 4a, 4a of the opening and the sunken portion 5 of the inner container 1 are in contact with each other without any clearance therebetween so as to be hermetically sealed.

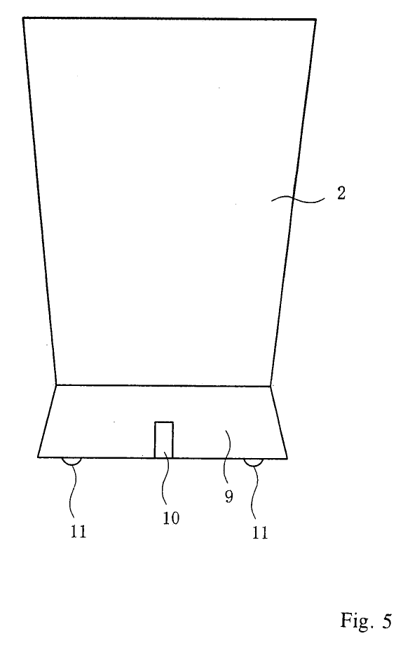

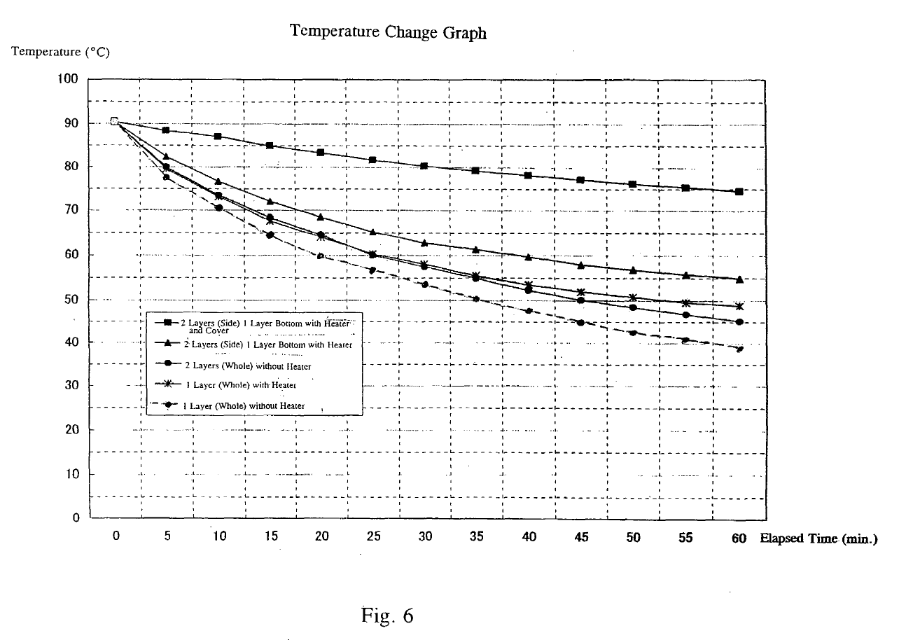

In addition, when heating and heat-retaining with an electric heater, the dual cup is placed on the heater as shown in FIG. 5 in such a way that the sunken portion 5 is fit into a recessed heating portion on the upper portion of the electric heater thereby making it possible to achieve an efficient heating and heat-retaining. Therefore, the sunken portion 5 should have a height enough to bring the bottom portion 6 of the sunken portion 5 into direct contact with the heating surface of the heater.

The shape of the outer container 2 is not limited to the examples, but any suitable shape can be selected according to the shape of the inner container 1 as is already stated above. Moreover, a handle (not shown) can be added to the outer container. Further, the outside of the outer container can be covered with plastic and so on so as to obtain higher heat-retaining effect.

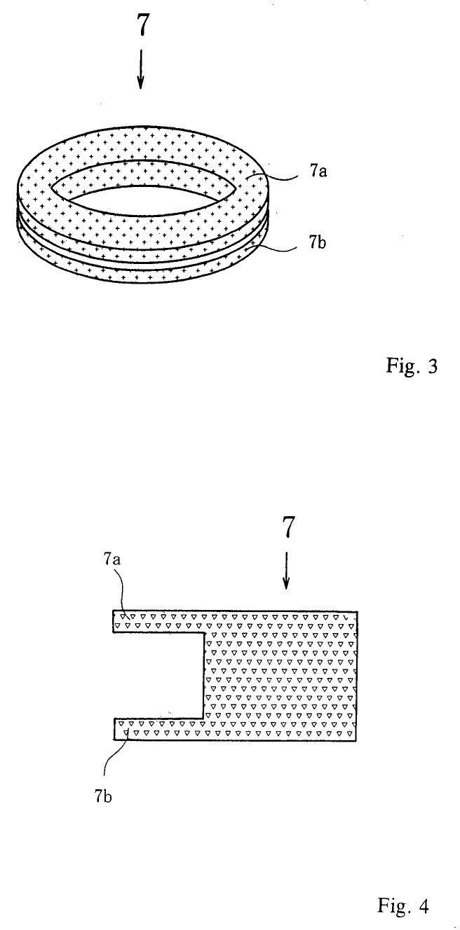

An elastic synthetic resin ring 7 has a generally U-shaped section. The ring having “a generally U-shaped section” means an elastic synthetic resin ring wherein an upper outer end portion 7a and a lower outer end portion 7b of the radially outer periphery are of a thin edged shape, as shown in FIGS. 3 and 4.

The elastic synthetic resin ring 7 seals a clearance between the inner container 1 and the outer container 2. It seals the space 8 between the inner container 1 and the outer container 2 so as to achieve air thermal insulation as well as to prevent water and so on from entering into the space 8 through an opening between the sunken portion 5 of the inner container 1 and the outer container 2 when washing the cup.

Accordingly, the radially inner side of the elastic synthetic resin ring 7 is in intimate contact with the inner container at the bent portion 5a of the sunken portion 5 of the inner container 1. The lower side of the ring 7 fills the gap between the sunken portion 5 of the inner container 1 and the opening of the outer container 2. The outer peripheral portion 7b is in close contact with the bottom portion of the outer container while the portion 7b is bent appropriately along the shape of the bottom portion of the outer container. The tip or the upper outer peripheral portion 7a is in intimate contact with the outer container 2.

In addition, silicone resin is most suitable for the material of the elastic synthetic resin 7. Even if a mere ring shape (not shown) is adopted, the elastic synthetic resin ring 7 can function as a contacting material by strong pushing, as long as a flexible material like silicone resin is used.

It is advantageous to have a generally U-shaped section because such a generally U-shaped section can easily cause the elastic synthetic resin ring 7 to be in close contact with the outer container along the shape thereof, as shown in FIG. 2, even if the synthetic resin ring 7 is more or less irregular in size and/or shape, and because such a generally U-shaped section enables efficient manufacturing.

The elastic synthetic resin ring 7 can be made of the above-stated silicone resin or other elastic synthetic resins which have a heat resistance to some extent and a plasticity, or other material having the similar functions or properties.

In addition, as explained in paragraph 26, it is not necessary to use an elastic synthetic resin ring 7, if the peripheral portions 4a, 4a of opening of the outer container 2 and the sunken portion 5 of the inner container 1 can be in contact with each other thereby allowing the sunken portion 5 to be fit into and fixed to the opening of the outer container 2 so as to be hermetically sealed.

The dual container of the present invention can be completed by inserting the inner container 1 into the outer container 2 with the inner container 1 in a state that the sunken portion 5 of the bottom portion of the inner container 1 is fit and fixed into the elastic synthetic resin ring 7, so that the inner container 1, the elastic synthetic resin ring 7 and the outer container 2 are in intimate contact with one another, and then welding the both of the containers at their upper ends 3. Thus, the dual container can be manufactured with a minimal number of members and simple process and can be provided at a low cost.

FIG. 5 is a front view showing a state of the dual cup of the present invention placed on a heater. The electric heater 9 with a switch 10 and legs 11 can be either a commercially available USB cup warmer or an electric heater powered by a dry battery.

FIG. 6 is a graph showing a temperature change over time for the dual cup relating to the present invention in each case with and without a cover or lid, with and without an electric heater (a heater), which is described in FIG. 6 as “two-layer (side) one-layer bottom with a heater and a cover”, “two-layers (side) one-layer bottom with a heater”, and for others “two-layers (whole) without a heater”, that is, a normal dual cup, and a normal cup with and without a heater.

According to the graphs, it is obviously understood that the dual cup of the present invention in either case with or without a cover can provide a sufficiently high effect for heat-retaining compared to a conventional dual cup or a normal cup.

According to the present invention, a dual container for heating and heat retaining is provided which can efficiently absorb heat through a bottom plate portion 6 made in one layer structure from a heater even with a weak electric source, which can still maintain ability of heat retaining of the dual container, and which can be manufactured with a minimum number of members in an easy way and at a low cost.

1. A metal dual container for heating and heat retaining, comprising a bottom plate portion made of one layer and a side portion made of two layers for sealing air therebetween to define an air thermal insulating layer.

2. A dual container for heating and heat retaining according to claim 1, comprising an outer container and an inner container, wherein a bottom portion of the outer container defines an opening surrounded by a remaining peripheral portion of the bottom portion, and wherein a bottom portion of the inner container is shouldered and a lower portion of the bottom portion is narrower under the shoulders, a bottom plate portion of the inner container is positioned below the opening of the outer container thereby to form said bottom plate portion of the dual container and respective side portions of the inner container and the outer container form said dual container side portion made of two layers.

3. A dual container for heating and heat retaining according to claim 2, wherein a clearance between the outer container and the inner container is sealed with an elastic synthetic resin ring at the bottom portion of the outer container.

4. A dual container for heating and heat retaining according to claim 3, wherein the elastic synthetic resin ring has a generally U-shaped section.
